(19) United States
(12) Patent Application Publication
(10) Pub. No.: US 2019/0160883 A1
(43) Pub. Date: May 30, 2019

(54) PNEUMATIC TIRE

(71) Applicant: TOYO TIRE & RUBBER CO., LTD., Itami-shi (JP)

(72) Inventor: Masashi Nakamura, Itami-shi (JP)

(73) Assignee: TOYO TIRE & RUBBER CO., LTD., Itami-shi (JP)

(21) Appl. No.: 16/182,116

(22) Filed: Nov. 6, 2018

(30) Foreign Application Priority Data
Nov. 27, 2017 (JP) 2017-226955

(51) Int. Cl. B60C 11/13

(52) U.S. Cl. CPC B60C 11/1353; B60C 2011/0355

(57) ABSTRACT

A pneumatic tire includes a shoulder portion that constitutes an outer portion of a ground contact surface in a tire width direction. A groove portion connected to the ground contact surface in a tire circumferential direction is formed in the shoulder portion. The groove portion includes a deep groove portion, and a shallow groove portion formed outside in a tire width direction with respect to the deep groove portion and having a small groove depth. The groove depth of the shallow groove portion cyclically increases and decreases in the tire circumferential direction.

This application claims priority based on Japanese Patent Application No. 2017-226955, the contents of which are incorporated herein by reference.

### BACKGROUND OF THE INVENTION

### Technical Field

The present invention relates to a pneumatic tire.

### Related Art

Conventionally, a pneumatic tire having a longitudinal narrow groove formed in a shoulder block to section the shoulder block into an outer shoulder block piece on a tread edge side, and an inner shoulder block piece, and having an edge siping having a smaller groove width than the groove width of the longitudinal narrow groove, and extending in the outer shoulder block piece in a tire circumferential direction has been known see Japanese Patent Publication No. 3133800).

However, the conventional pneumatic tire is provided with the longitudinal narrow grooves formed in a shoulder portion have a uniform depth in the tire circumferential direction. In this case, rigidity in a tire radial direction becomes uniform, and therefore a stress may be concentrated at a specific position when a ground contact pressure is applied.

### SUMMARY

An object of the present invention is to provide a pneumatic tire capable of preventing cracks generated by concentration of distortion at a specific position of a shoulder portion.

The present invention provides, as a means for solving the object, a pneumatic tire including a shoulder portion that constitutes an outer portion of a ground contact surface in a tire width direction. A groove portion connected to the ground contact surface in a tire circumferential direction is formed in the shoulder portion. The groove portion includes a deep groove portion, and a shallow groove portion formed outside in a tire width direction with respect to the deep groove portion and having a small groove depth. The groove depth of the shallow groove portion cyclically increases and decreases in the tire circumferential direction.

With this configuration, the shallow groove portion whose groove depth cyclically increases and decreases in the tire circumferential direction not only prevents uneven wear at the outer portion (shoulder end portion) of the shoulder portion in the tire width direction with respect to the deep groove portion, but also disperses a rigidity balance in the tire radial direction. This configuration therefore prevents cracks generated by a stress which is produced by a ground contact pressure applied to the shoulder end portion, and is concentrated on a specific identical circumference in the tire radial direction.

It is preferable that the shallow groove portion includes a first shallow groove portion and a second shallow groove portion disposed side by side in the tire width direction. The first shallow groove portion and the second shallow groove portion preferably have opposite phases of increase and decrease of the groove depth.

With this configuration, rigidity balances adjusted by the first shallow groove portion and the second shallow groove portion can be equalized in the tire circumferential direction. Accordingly, further reduction of concentration of the ground contact pressure, and therefore further reduction of cracks are achievable.

It is preferable that the first shallow groove portion and the second shallow groove portion have an identical shape.

With this configuration, variations in rigidity obtained for each of the first shallow groove portion and the second shallow groove portion can be reduced.

It is preferable that the shallow groove portion has a groove depth which increases and decreases by a length of ⅓ or smaller of a groove depth of the deep groove portion.

With this configuration, a change of rigidity produced by increase and decrease in the groove depth can be reduced within an appropriate range.

Particularly, the shallow groove portion preferably has a groove depth which increases and decreases by a length within a range from ⅓ to ⅔ of a groove depth of the deep groove portion.

With this configuration, the rigidity balance in the tire radial direction can be equally varied in three stages. More specifically, the rigidity becomes lowest in the outside region in the tire radial direction as a shallow groove portion forming region, becomes higher in the inside region, and becomes middle rigidity in the intermediate region.

The shallow groove portion preferably has a groove depth which increases and decreases in the tire circumferential direction in one cycle within a range from two to five times (inclusive) a difference between a maximum value and a minimum value of the groove depth.

With this configuration, further reduction of uneven wear and cracks can be achieved by appropriately balancing the rigidity in the tire circumferential direction.

According to the present invention, the shallow groove portion whose groove depth cyclically increases or decreases in the tire circumferential direction is formed outside in the tire width direction with respect to the deep groove portion formed in the shoulder portion. In this case, groove bottoms are not located on an identical circumference, and therefore a stress generated by a ground contact pressure is not concentrated at a specific position. Accordingly, equalization of the ground contact pressure of the shoulder portion, and therefore generation of uneven wear are reduced without generating cracks or the like.

### BRIEF DESCRIPTION OF THE DRAWINGS

The foregoing and the other feature of the present invention will become apparent from the following description and drawings of an illustrative embodiment of the invention in which:

FIG. 1 is a meridian half cross-sectional view of a pneumatic tire according to the present embodiment;

FIG. 2 is a partially enlarged view showing a rib end portion in FIG. 1;

FIG. 3 is a view showing a groove bottom shape of a shallow groove portion in FIG. 1;

FIG. 4 is a view showing a groove bottom shape of a shallow groove portion according to another embodiment; and

FIG. 5 is a diagram showing a groove bottom shape of a shall groove portion according to a further embodiment.

### DETAILED DESCRIPTION OF EMBODIMENT

An embodiment according to the present invention is hereinafter described with reference to the accompanying drawings. It should be noted that the following description is essentially presented by way of example, and not intended to limit the present invention, applicable ranges of the present invention, or purposes of use of the present invention.

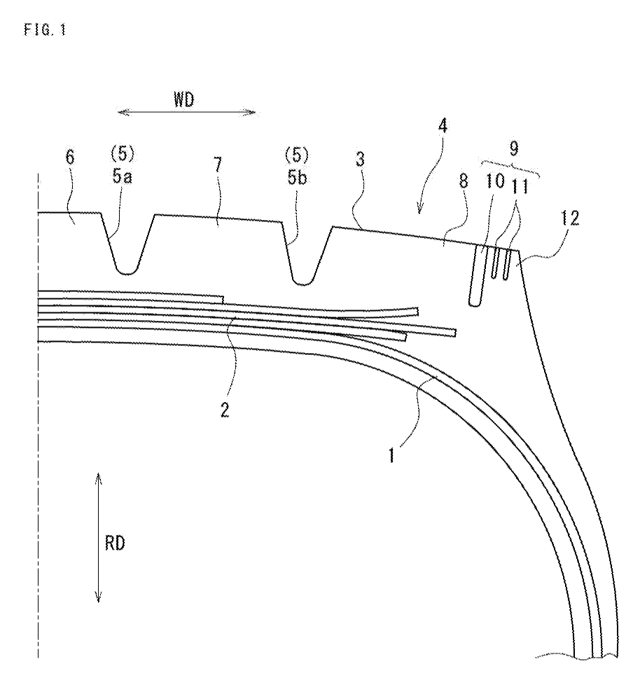

FIG. 1 is a meridian half cross-sectional view of a pneumatic tire in the present embodiment. According to this pneumatic tire, bead cores (not shown) annularly connected in a tire circumferential direction are disposed on both sides in a tire width direction WD. A carcass ply 1 is extended between the bead cores. A plurality of belts 2 are wound around a center portion of the carcass ply in the tire width direction WD outside in a tire radial direction RD. The outside of the belts 2 in the tire radial direction RD constitutes a tread portion 4 which includes a ground contact surface 3 in contact with a road surface during traveling.

A plurality of main grooves 5 connected in the tire circumferential direction are formed in the tread portion 4. The main grooves 5 are constituted by four grooves, i.e., two first main grooves 5a on the center side in the tire width direction WD, and two second main grooves 5b on the outer side. A center rib 6 connected in the tire circumferential direction is formed between the first main grooves 5a, a mediate rib 7 is formed between the first main groove 5a and the second main groove 5b, and a shoulder rib 8 is extended toward the outside in the tire width direction from the second main groove 5b.

A plurality of groove portions 9 extending in the tire circumferential direction are formed in an outer portion of the shoulder rib 8 in the tire width direction WD. Each of the groove portions 9 includes a deep groove portion 10 and a shallow groove portion 11.

The deep groove portion 10 has a groove depth substantially the same as the depth of the main grooves 5, but the groove width of the deep groove portion 10 is sufficiently reduced (in this example, the groove width of the deep groove portion 10 is about 90% of the groove width of the main grooves 5). In addition, the groove bottom of the deep groove portion 10 has a curved surface having an arcuate cross section when viewed in a meridian section.

The shallow groove portion 11 is formed in a rib end portion 12 which is an outer portion in the tire width direction WD with respect to the deep groove portion 10. The shallow groove portion 11 has a groove depth smaller than the groove depth, of the deep groove portion 10 (in this example, the groove depth of the shallow groove portion 11 is increased or decreased from about 50% of the groove depth of the deep groove portion 10 as described below), and has a width smaller than the width of the deep groove portion 10 (in this example, the groove width of the shallow groove portion 11 is about 30% of the groove width of the deep groove portion 10). Similarly to the deep groove portion 10, a groove bottom of the shallow groove portion 11 has a curved surface having an arcuate cross section when viewed in a meridian cross section.

The shallow groove portion 11 includes a first shallow groove portion 13 located inside in the tire width direction WD, and a second shallow groove portion 14 located outside in the tire width direction WD. The first shallow groove portion 13 and the second shallow groove portion 14 have the same shape. The groove depths of these grooves are configured to increase or decrease in a constant cycle in the tire circumferential direction as shown in FIG. 3. When viewed in the tire circumferential direction, the rate of increase and the rate of decrease of each of the groove depths are equalized, forming a smooth wavy shape. In this example, the groove bottoms are formed to produce a sine curve. When the groove depths are uniform, rigidity largely changes at the groove bottoms as boundaries. In this case, distortion concentrates on the groove bottom portions and generates cracks. However, this problem can be solved by adopting the configuration described above. More specifically, when each of the groove depths are increased and decreased in the tire circumferential direction, rigidity is varied in the tire radial direction within this increase/decrease range. In this condition, distortion is dispersed, and therefore concentration of the distortion at one point is avoidable. Accordingly, cracks generated by concentration of the distortion at one point can decrease.

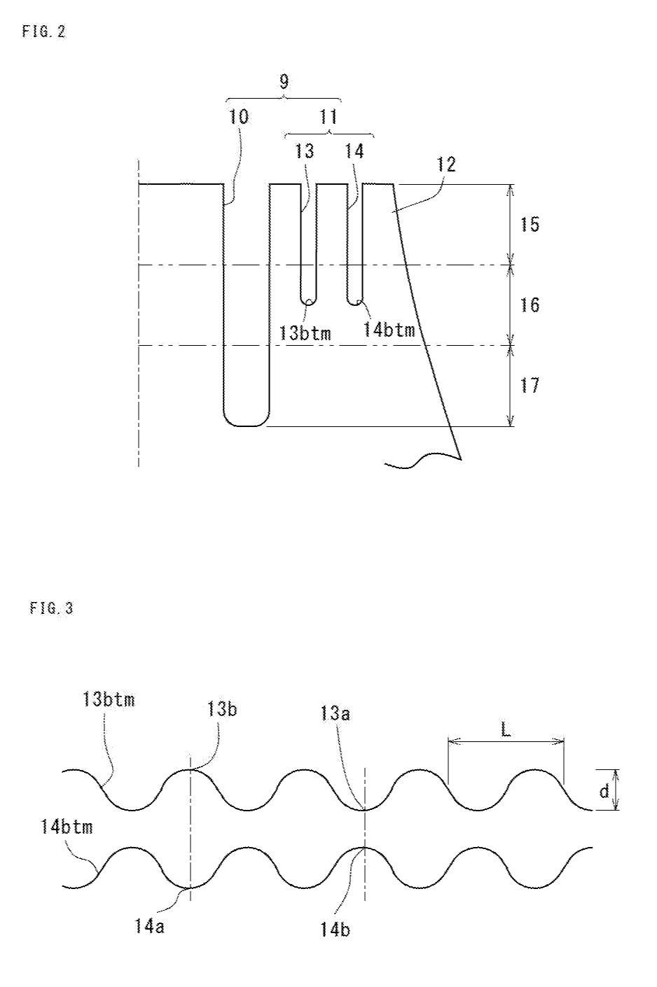

When the groove depth of the deep groove portion 10 is equally divided into three divisions in the tire radial direction as shown in FIG. 2, a groove bottom 13btm of the first shallow groove portion 13 and a groove bottom 14btm of the second shallow groove portion 14 are located in an intermediate region 16 which is one of the divisions. The groove bottom 13btm of the first shallow groove portion 13 and the groove bottom 14btm of the second shallow groove portion 14 are configured to increase and decrease within a range equal to or smaller than ⅓ of the groove depth of the deep groove portion 10. Accordingly, different rigidity of the rib end portion 12 is obtained for each of a surface region 15 from the surface of the shoulder rib 8 to ⅓ of the groove depth of the shallow groove portion 11, the intermediate region 16 from the surface region 15 to ⅔ of the groove depth of the shallow groove portion 11, and an inner region 17 reaching the groove bottoms 13btm and 14btm. However, the range of increase and decrease in the groove depth of the shallow groove portion 11 may cover the whole of the intermediate region 16, or may cover only a part of the intermediate region 16. When the groove depth of the shallow groove portion 11 increases and decreases within only a part of the intermediate region 16, the shallow groove portion 11 may be displaced toward either the surface region side, the center, or the inner region side.

In this manner, an excessive change of rigidity in the tire radial direction is avoidable by providing a mixed area of a portion including the shallow groove portion 11 and a portion not including the shallow groove portion 11 between a region including the shallow groove portion 11 and a region not including the shallow groove portion 11. In this case, a stress is not concentrated at a specific position in the tire radial direction (i.e., groove bottom portion on identical circumference). Accordingly, generation of cracks is avoidable.

As shown in FIG. 3, the groove bottom 13btm of the first shallow groove portion 13 and the groove bottom 14btm of the second shallow groove portion 14 have opposite phases of the increase/decrease cycle. In other words, a shallowest portion 14b of the second shallow groove portion 14 is positioned in a deepest portion 13a corresponding to the deepest position of the first shallow groove portion 13, while a deepest portion 14a of the second shallow groove portion 14 is positioned in a shallowest portion 13b corresponding to the shallowest position of the first shallow groove portion 13. Accordingly, variations in rigidity in the tire circumferential direction can also be reduced.

A length L of each of the first shallow groove portion 13 and the second shallow groove portion 14 in the tire circumferential direction in one cycle is set to a value within a range from two to five times inclusive) a distance d in the tire radial direction between the deepest position and the shallowest position of the groove bottoms 13btm and 14btm (amplitude of each of groove bottoms 13btm and 14btm when these groove bottoms are sine curves). When the length L is smaller than two times the distance d, each radii of curvature of the groove bottoms 13btm and 14btm extending in the tire circumferential direction decreases. In this case, cracks may be generated. On the other hand, when the length L exceeds five times the distance d, a rigidity balance in the tire radial direction is likely to concentrate on a specific circumference. In this case, distortion concentrates and easily generates cracks. However, generation of such cracks can be reduced by setting the length L to a value within the range from two to five times (inclusive) the distance d.

The present invention is not limited to the configuration described in the above embodiment, but may include various modifications.

In the above embodiment, the two shallow groove portions 11 are provided. However, the one, three or more shallow groove portions 11 may be provided. However, the number of the shallow groove portions 11 depends on the width of the rib end portion 12 formed by the deep groove portion 10. When the three or more shallow groove portions 11 are provided, the phases of the shallow groove portions 11 are preferably shifted for each 1 cycle/n (n: number of shallow groove portions 11).

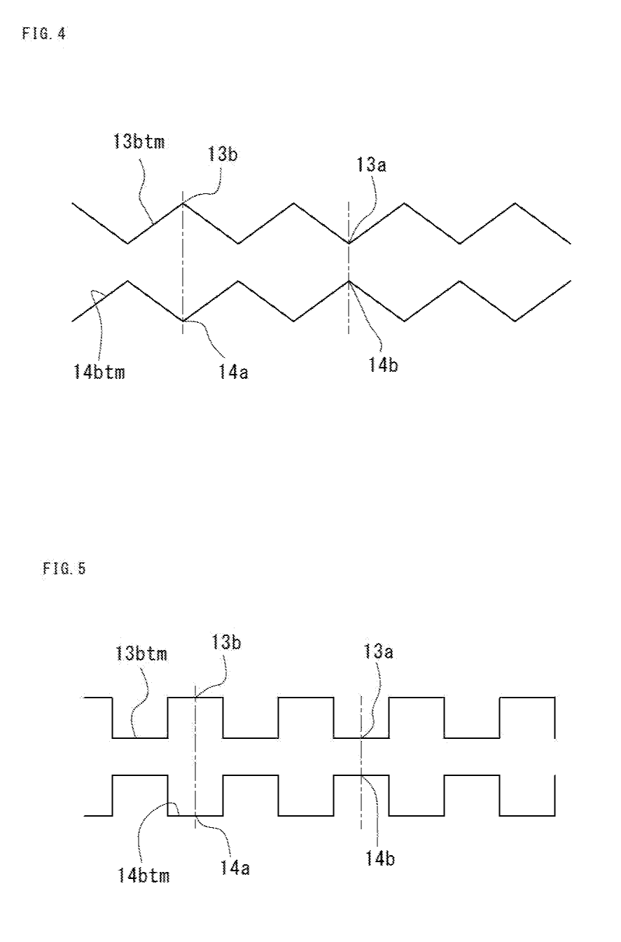

In the above embodiment, each of the groove bottom 13btm of the first shallow groove portion 13 and the groove bottom 14btm of the second shallow groove portion 14 is constituted by a sine curve. However, each of the groove bottom 13btm and the groove bottom 14btm may be a triangular pulse shown in FIG. 4, or a rectangular pulse shown in FIG. 5. In these cases, opposite phases are preferably given similarly to the above embodiment. A smooth wavy shape is preferably generated. When the three or more shallow groove portions 11 each having this shape are provided, the phases are shifted in a manner similar to the above shift manner.

What is claimed is:

1. A pneumatic tire comprising a shoulder portion that constitutes an outer portion of a ground contact surface in a tire width direction,
wherein
a groove portion connected to the ground contact surface in a tire circumferential direction is formed in the shoulder portion,
the groove portion includes a deep groove portion, and a shallow groove portion formed outside in a tire width direction with respect to the deep groove portion and having a small groove depth, and
the groove depth of the shallow groove portion cyclically increases and decreases in the tire circumferential direction.

2. The pneumatic tire according to claim 1, wherein
the shallow groove portion includes a first shallow groove portion and a second shallow groove portion disposed side by side in the tire width direction, and
the first shallow groove portion and the second shallow groove portion have opposite phases of increase and decrease of the groove depth.

3. The pneumatic tire according to claim 2, wherein the first shallow groove portion and the second shallow groove portion have an identical shape.

4. The pneumatic tire according to claim 1, wherein the shallow groove portion has a groove depth which increases and decreases by a length of ⅓ or smaller of a groove depth of the deep groove portion.

5. The pneumatic tire according to claim 2, wherein the shallow groove portion has a groove depth which increases and decreases by a length of ⅓ or smaller of a groove depth of the deep groove portion.

6. The pneumatic tire according to claim 3, wherein the shallow groove portion has a groove depth which increases and decreases by a length of ⅓ or smaller of a groove depth of the deep groove portion.

7. The pneumatic tire according to claim 1, wherein the shallow groove portion has a groove depth which increases and decreases by a length within a range from ⅓ to ⅔ of a groove depth of the deep groove portion.

8. The pneumatic tire according to claim 2, wherein the shallow groove portion has a groove depth which increases and decreases by a length within a range from ⅓ to ⅔ of a groove depth of the deep groove portion.

9. The pneumatic tire according to claim 3, wherein the shallow groove portion has a groove depth which increases and decreases by a length within a range from ⅓ to ⅔ of a groove depth of the deep groove portion.

10. The pneumatic tire according to claim 4, wherein the shallow groove portion has a groove depth which increases and decreases by a length within a range from ⅓ to ⅔ of a groove depth of the deep groove portion.

11. The pneumatic tire according to claim 1, wherein the shallow groove portion has a length in the tire circumferential direction in one cycle within a range from two to five times (inclusive) a difference between a maximum value and a minimum value of a groove depth which is a groove depth of the shallow groove and increases and decrease.

12. The pneumatic tire according to claim 2, wherein the shallow groove portion has a length in the tire circumferential direction in one cycle within a range from two to five times (inclusive) a difference between a maximum value and a minimum value of a groove depth which is a groove depth of the shallow groove and increases and decrease.

13. The pneumatic tire according to claim 3, wherein the shallow groove portion has a length in the tire circumferential direction in one cycle within a range from two to five times (inclusive) a difference between a maximum value and a minimum value of a groove depth which is a groove depth of the shallow groove and increases and decrease.

14. The pneumatic tire according to claim 4, wherein the shallow groove portion has a length in the tire circumferential direction in one cycle within a range from two to five times (inclusive) a difference between a maximum value and a minimum value of a groove depth which is a groove depth of the shallow groove and increases and decrease.

15. The pneumatic tire according to claim 1, wherein the shallow groove portion has a length in the tire circumferential direction in one cycle within a range from two to five times (inclusive) a difference between a maximum value and a minimum value of a groove depth which is a groove depth of the shallow groove and increases and decrease.
